(19) United States
(12) Patent Application Publication
(10) Pub. No.: US 2016/0117725 A1
(43) Pub. Date: Apr. 28, 2016

(54) SYSTEM AND METHOD FOR IMPROVED PERSONALIZATION USING MOBILE TECHNOLOGY

(71) Applicant: Sailthru, Inc., New York, NY (US)

(72) Inventors: Neil James Capel, New York, NY (US); Ian Bradford White, Brooklyn, NY (US); Nick Gundry, New York, NY (US)

(21) Appl. No.: 14/523,513

(22) Filed: Oct. 24, 2014

(51) Int. Cl. G06Q 30/02

(52) U.S. Cl. CPC G06Q 30/0254; G06Q 30/0261; G06Q 30/0267; G06Q 30/0266

(57) ABSTRACT

Disclosed is a system and method for determining that a consumer will purchase a product or service based on a location of the consumer's vehicle and purchasing habit. Electronic merchant information and purchasing information is processed to predict a future purchase from a merchant. Further processing is triggered of location information that represents a location of the consumer to enable one of the merchants to take action in view of the predicted future purchase. A notification is received over from a computing device associated with one of the respective merchants that represents a purchase by the consumer. The purchase by the consumer matches the predicted future purchase. Information associated with the notification is selectively stored, using at least one processor, in the at least one database as part of the electronic purchasing information in the event that the matching purchase is within a prescribed time of the triggered processing.

### FIELD

The present invention relates generally to networking and, more particularly, to providing personalized service.

### BACKGROUND OF THE INVENTION

Various providers of products and services (e.g., merchants) continue to seek new ways to engage customers. Push notifications, for example, enable a merchant to send a message to a group of users at some specific time, for example to the users' mobile devices. When received, the devices create an alert, and the next time the users activate their devices, the notification is visible. The users then decide the next step. Moreover, many such alerts are generic and not of interest, and detract users' attention.

Unfortunately, it is recognized that too often users simply take no further action and/or forget about the message they just received.

### SUMMARY OF THE INVENTION

The present application addresses these and other concerns, including by providing merchants and other interested parties with new and powerful ways to engage users of mobile computing devices, such as smartphones and tablet computers, and automobile in-dash computing devices, including for those users who are in transit.

In one or more implementations, the present application determines that a consumer will purchase a product or service based, at least in part, on a location and/or trajectory of a vehicle the consumer is in and a purchasing habit of the consumer. At least one database is accessed that includes electronic merchant information and electronic purchasing information. The electronic merchant information can include, for each of a plurality of respective merchants, at least one of a name and a location of the product and/or service, and the electronic purchasing information can include, for each of a plurality of respective consumers, past purchasing behavior relating to the products and/or services sold by at least one of the respective merchants. Thereafter, using at least one processor, at least some of the electronic merchant information and the electronic purchasing information is processed to predict a future purchase of the product or service by the consumer from one of the respective merchants. Further processing is triggered, using at least one processor, of location information that represents a location of the consumer to enable the one of the respective merchants to take action in view of the predicted future purchase. Thereafter, a notification is received over a data communication network, using at least one processor, from a computing device associated with one of the respective merchants that represents a purchase by the consumer. The purchase by the consumer matches the predicted future purchase. Information associated with the notification is selectively stored, using at least one processor, in the at least one database as part of the electronic purchasing information in the event that the matching purchase is within a prescribed time of the triggered processing.

In one or more implementations, a prompt is generated using at least one processor that is usable to receive an instruction from the consumer to order the products and/or services from one of the respective merchants. The prompt is transmitted using at least one processor to at least one of a computing device operated by the consumer and a computing device operated by one of the respective merchants. The computing device operated by the consumer can be a mobile computing device configured with a software application, and the prompt can be processed by the mobile computing device configured with the software application.

In one or more implementations, the software application interfaces, at least in part, with a display screen configured in an automobile, and any instruction provided by the consumer to order the products and/or services is acknowledged in a graphical user interface provided in the display screen. Further, payment for the purchase can be made in advance of the purchase or substantially in real-time. The consumer's location can be derived from a global positioning system. Further, an instruction to order the product/service can be received from the computing device operated by the consumer, and an order can be transmitted using at least one processor, for the products and/or services to one of the respective merchants as a function of the received instruction. Moreover, a notification can be received that the consumer did not respond to the prompt.

In one or more implementations, electronic purchasing information can include at least one of: a web site previously visited by the consumer; products and/or services previously viewed by the consumer; and an advertisement that was provided to the consumer, wherein the processing of at least some of the electronic merchant information and the electronic purchasing information to predict the future purchase further comprises accounting for at least one of: the web site previously visited by the consumer; the product and/or service previously viewed by the consumer; and the advertisement that was provided to the consumer.

Other features and advantages of the present application will become apparent from the following description of the invention that refers to the accompanying drawings.

### BRIEF DESCRIPTION OF DRAWINGS/FIGURES

Further aspects of the present disclosure will be more readily appreciated upon review of the detailed description of its various embodiments, described below, when taken in conjunction with the accompanying drawings, of which:

FIG. 1 is a block diagram that illustrates an example arrangement of hardware devices and associated flow of information, in connection with an example implementation of the present application;

FIG. 2 is a block diagram that illustrates functional elements of one or more of a data processing apparatus and/or other computing device in accordance with one or more implementations of the present application;

FIG. 3 is a block diagram representing a plurality of modules that provide functionality, such as shown and described herein;

FIG. 4 is a block diagram illustrating devices and parties associated with an example implementation of the present patent application;

FIG. 5 is a block diagram illustrating information stored in one or more one or more storage/database devices, and that is accessible to devices in connection with an implementation of the present application;

FIG. 6 illustrates an example an example display screen that is provided in a vehicle dashboard in connection with an example implementation;

FIG. 7 is an example data entry display screen that is usable to receive information from users to set one or more conditions associated with communications for product/service purchasing;

FIG. 8 is a flow diagram is described showing a routine that illustrates a broad aspect of a method for providing a targeted recommendation for a product or service in accordance with at least one implementation disclosed herein; and

FIG. 9 is a flowchart illustrating steps associated with an example implementation of the present application.

### DETAILED DESCRIPTION

By way of overview and introduction, systems and methods are provided herein to engage user computing devices including devices that interface with or are integrated in motor vehicles, to generate notifications of opportunities in the marketplace. In addition, system and methods are provided to effectuate transactions, such as small purchases of products and/or services. Moreover, user computing devices can be engaged as a function of the location of the user computing devices. For example, product information, special offers or the like can be provided substantially automatically in response to a determination that a user computing device is present within a geographic area. Engaging user computing devices can include determining that a consumer who is associated with a respective user computing device is likely to purchase a product or service based on a location of a vehicle that the consumer is traveling in. Other information can include purchasing habits of the consumer, which can be based on previous purchases, browsing history or other consumer habit information representing consumer purchases.

In one or more implementations, the present application provides for access to one or more databases to provide access and process information in order to predict future purchases by one or more users. The database(s) accessed in accordance with the present application can include merchant information representing, for example, name and contact information, including location information of merchants. Additionally, the database(s) include information associated with consumers, and can store information on particular consumers who have installed a respective mobile app on a mobile computing device (e.g., a smartphone).

The present application enables use of information for prediction of various actions to be taken by merchants, such as to prepare and order and that is based on consumer location information, past-purchasing behavior or other activity. In addition, information is usable to process purchase transactions in advance of a consumer picking up an order, and to cancel an order in the event a consumer changes his/her mind and elects not to pick up an order. In addition, the present application is configured to receive one or more notifications from a merchant representing, for example, that a consumer has made a purchase that matches the prediction.

In one or more implementations, a prompt can be provided to computing device associated with a user representing an option for the user to purchase a product/service. A graphical user interface can be provided in a display screen provided within a vehicle, such as integrated into the vehicle's dashboard. One or more modules can operate to determine a particular location or traveling trajectory of a vehicle, and to provide options to receive input from the user, such as in response to a prompt to purchase a product/service at a merchant's location near or on route to the user. In response to an instruction (e.g., a response to a prompt) to consummate a purchase for a product or service, order information can be transmitted to a merchant. Payment for the order may have been made previously, for example, a user can submit prepayment for products and/or services, and an account can be managed and/or maintained in which prepayment is applied.

In one or more implementations, the present application includes functionality that configures a processor to predict a consumer's purchase of a product and/or service, and that effects purchase of the product/service even in advance of the consumer instigating the purchase. This can be occur, at least in part, by accessing information associated with a user's purchasing habits, as well as one or more records of a user's day-to-day activities.

For example, a traveling salesperson who works within a specific geographic region typically frequents a particular coffee shop to get a cup of coffee and a donut at 7:15 a.m. on Mondays. As the salesperson is driving, the location of the salesperson's mobile computing device and/or vehicle is determined to be either in the vicinity of or on a trajectory toward the merchant. While the salesperson is driving, there is a likelihood that the salesperson is going to want the coffee and donut. The time of day can be processed to assist with a determination that the salesperson is likely to repeat previous actions, consistent with known human patterns.

Continuing with the present example, payment for the order can be made in advance of the order. For example, loyalty card accounts can be tracked and/or managed by the present application and payment for products and/or services can be made thereby. Alternatively, the present application supports maintaining and/or managing accounts for registered users who provide capital on account for future payments. Other suitable payment techniques and methods are supported as well.

Thus, the present application provides personalized services that can be specific to individual purchasing habits, and that is location aware and provides for safe and convenient ordering of products and services. Various forms of messaging is supported, such as when an individual is driving in a particular location. A message can appear that it is recognized that the individual is near a provider of products and services and a recount of the user's common orders is provided along with options to reorder. Alternatively, a full menu of choices can be provided to a user, such as via a graphical user interface and a menu on the user's automobile dashboard. In addition to dashboard technology, the present application supports implementation of a mobile app with other suitable communication platforms, such as text messaging, telephonic implementations or the like.

In one or more implementations of systems and methods disclosed herein, when a user computing device responds to the transmitted signal, information can be accessed and/or received that represents the computing device, the user, and/or activity associated therewith. For example, detailed information regarding a user's purchasing and browsing history can be accessed and used to engage the user in meaningful ways. Such information can be obtained or accessed from one or more databases that are accessible over a data communication network or locally. For example, information stored in one or more user profiles can be accessed to garner additional information associated with the user of the computing device. Furthermore, information can be obtained as a function of one or more email campaigns, such as shown and described in co-pending and commonly assigned U.S. patent application Ser. No. 14/262,361 and filed Apr. 25, 2014, the entirety of which is incorporated by reference as if expressly set forth herein. Alternatively (or in addition), information can be obtained as a function of one or more Push Notifications. The information can be used to generate a recommendation or other course of action, and can be delivered to a consumer or party associated with a merchant.

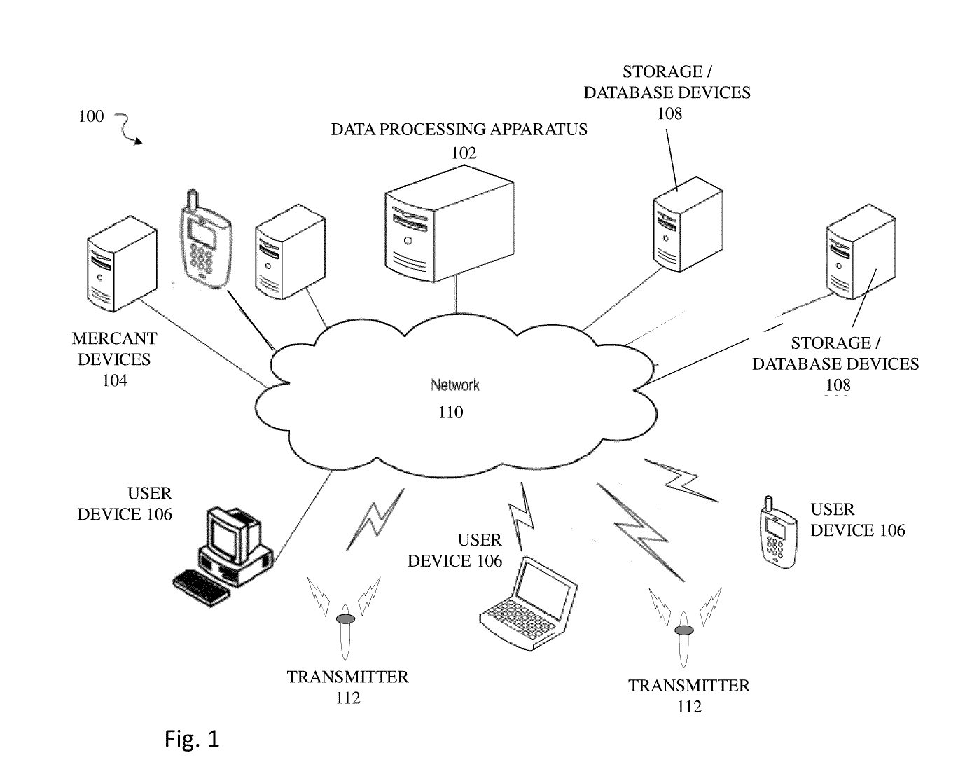

Referring to the drawings, in which like reference numerals refer to like elements, FIG. 1 is a block diagram illustrating an example implementation of the present application and that represents an association of a plurality of devices and the flow of information associated with the devices. In the example shown in FIG. 1, various computing devices 102, 104, 106 and 108 are shown, each capable of executing desktop and/or mobile computing device web browser application(s) including INTERNET EXPLORER, CHROME, FIREFOX, and other (e.g., SAFARI, OPERA). In addition to standard web browser application functionality, user information can be gathered via Push Notifications, and information can be retrieved from a computing device using a “REST” interface. Various mobile devices running different operating systems are shown, including IOS, ANDROID and other (e.g., PALM, WINDOWS or other mobile device operating system).

In the example shown in FIG. 1, data processing apparatus 102 is operatively coupled to the computing devices 104, 106 and 108. Devices 104, 106 and 108 can be respectively operated by one or more merchants (merchant computing devices 104) and consumers (user computing devices 106). Merchants can include, for example, retail providers of products and/or services, and consumers can include past and/or future purchasers thereof. Storage/database devices 108 can include one or more computing devices that are operable to store various information including, for example, personal or identifying information about a user, information identifying a respective computing device and/or software operating thereon, user activity (e.g., browsing history, purchase history, information about a respective social network, social actions or activities, profession, preferences or a current location), or the like. In the example implementation illustrated in FIG. 1 the designation of storage/database devices 108 to appear as separate and distinct from merchant computing devices 104 and user computing devices 106. It is to be understood that storage/database devices 108 do not have to be separate from devices 102, 104 or 106 and that storage/database devices 108 can be the same as or otherwise comprise a subset of devices 102, 104 and/or 106.

In addition, certain data can be treated in one or more ways before it is stored or used, so that personally identifiable information is not displayed. For example, a person's identification number can be used to retrieve detailed information about a user, and which can be transmitted to a merchant to enable the merchant to provide specialized service. The merchant (or the specific employee or agent of the merchant who interacts with the user) may not be provided with personally identifiable information about the user. In this way, a user's anonymity can be preserved, for example to maintain expectations of anonymity of typical shoppers in public retail spaces. Also illustrated in FIG. 1 is a network 110, which can be configured as a local area network (LAN), wide area network (WAN), Peer-to-Peer network (“P2P”), Multi-Peer network, the Internet, one or more telephony networks or a combination thereof, that is operable to connect data processing apparatus 102, merchant devices 104, user devices 106 and other storage/database devices 108. Though many of the examples and implementations shown and described herein relate to product and/or service recommendations, many other forms of content can be provided and/or delivered by system 100.

Continuing with reference to FIG. 1, transmitter 112 is shown that is configured to transmit wirelessly a signal that can be received by a computing device, such as mobile user computing device 106. As shown in FIG. 1, the transmitter 112 is configured as a stand-alone device that can be configured to send information via network 110 (e.g., via Wi-Fi, BLUETOOTH or other suitable protocol). The transmitter 112 can be configured in various other ways, including as a mobile computing device. Moreover, the transmitter 112 can be configured in various sizes and shapes, and can be, for example, several centimeters in length, and can broadcast hundreds of feet or more. The transmitter 112 can be configured to operate in a send-only mode, in which a signal is transmitted and the transmitter 112 does not receive any acknowledgment or indication that the signal has been received by a device. The transmitter 112 can be configured to transmit a low power radio frequency signal having a frequency range, for example, within about 2.40-2.480 GHz. In one or more implementations, a user computing device 106 is configured with software to receive, recognize and/or respond to the signal, for example, by sending and/or requesting information via network 110 (e.g., a P2P network or Multi-peer network) to one or more of a data processing apparatus 102 and a merchant computing device 104. In one or more implementations, the user computing device(s) 106 can receive a signal from the transmitter 112 without having to establish a connection to the transmitter 112 (e.g., via a BLUETOOTH handshake process). Such a configuration results in improved network performance and battery life.

In response to a signal, transmitted from the transmitter 112, from a computing device 106, one or more of computing devices 102, 104 and 108 can be alerted of a user's presence in a respective location. Accordingly, information requests can be received from one or more devices 102, 104, 106 and 108. The requests that are made can regard, for example, information associated with the user computing device 106 and/or the user operating the device 106. Information retrieved in response to the requests can be processed, for example, to identify one or more specific products and/or services provided by a respective merchant and, thereafter, to form a respective recommendation or suggestion in accordance with the product(s) and/or service(s).

Additional functionality provided herein and in accordance with one or more of computing devices 102, 104 and 108 and transmitter 112 is shown and described in commonly assigned and co-pending U.S. patent application Ser. No. 14/304,628, filed on Jun. 13, 2014 and entitled SYSTEM AND METHOD FOR IMPROVED PERSONALIZATION USING BEACON TECHNOLOGY, the entire contents of which is hereby incorporated by reference as if set forth in its entirety herein.

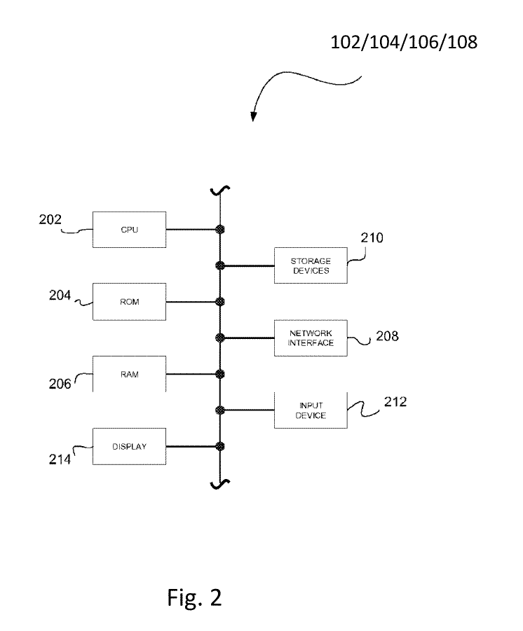

FIG. 2 is a block diagram that illustrates functional elements of one or more of data processing apparatus 102 or computing device (104, 106, 108) and preferably include one or more central processing units (CPU) 202 used to execute software code in order to control operations, including of data processing apparatus 102, read only memory (ROM) 204, random access memory (RAM) 206, one or more network interfaces 208 to transmit and receive data to and from other computing devices across a communication network, storage devices 210 such as a hard disk drive, solid state drive, floppy disk drive, tape drive, CD-ROM or DVD drive for storing program code, databases and application code, one or more input devices 212 such as a keyboard, mouse, track ball and the like, and a display 214.

The various components of devices 102, 104, 106 and/or 108 need not be physically contained within the same chassis or even located in a single location. For example, storage device 210 may be located at a site which is remote from the remaining elements of computing devices 102, 104, 106 and/or 108, and may even be connected to CPU 202 across communication network 106 via network interface 208.

The functional elements shown in FIG. 2 (designated by reference numbers 202-214) are preferably the same categories of functional elements preferably present in computing device 104, 106 and/or 108. However, not all elements need be present, for example, storage devices in the case of PDAs, and the capacities of the various elements are arranged to accommodate expected user demand. For example, CPU 202 in computing device 104, 106 and/or 108 can be of a smaller capacity than CPU 202 as present in data processing apparatus 102. Similarly, it is likely that data processing apparatus 102 will include storage devices 210 of a much higher capacity than storage devices 210 present in computing device 104, 106 and/or 108. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, OBJECTIVE C, ANDROID, TORR and various web application development environments.

As used herein, references to displaying data on computing device 104, 106 and/or 108 refer to the process of communicating data to the computing device 104, 106 and/or 108 across communication network 106 and processing the data such that the data can be viewed on the user computing device 104, 106 and/or 108 display 214 using a web browser, custom application or the like. The display screens on computing device 104, 106 and/or 108 present areas within system 100 such that a user can proceed from area to area within the system 100 by selecting a desired link. Therefore, each user's experience with system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of system 100.

Although the present application is described by way of example herein in terms of a web-based system using web browsers, custom applications and a web site server (data processing apparatus 102), and with mobile computing devices, system 100 is not limited to that particular configuration. It is contemplated that system 100 can be arranged such that computing device 104, 106 and/or 108 can communicate with, and display data received from, data processing apparatus 102 using any known communication and display method, for example, using a non-Internet browser Windows viewer coupled with a local area network protocol such as the Internetwork Packet Exchange (IPX). It is further contemplated that any suitable operating system can be used on computing device 104, 106 and/or 108, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, MAC OS, OSX, LINUX, IOS, ANDROID and any suitable PDA or palm computer operating system.

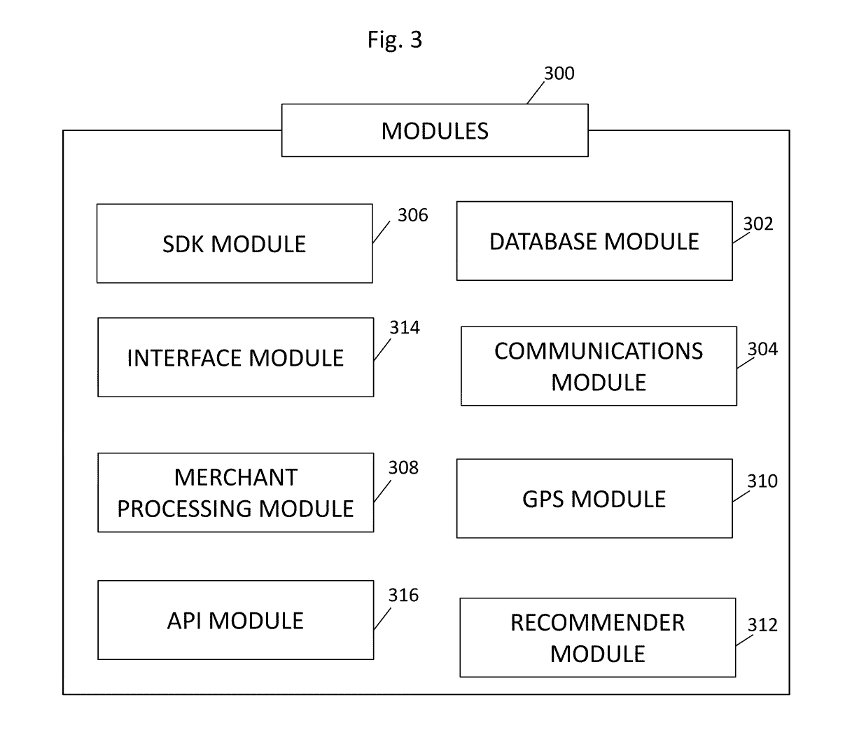

FIG. 3 is a block diagram representing a plurality of modules 300 that provide functionality, such as shown and described herein. Depending upon a respective implementation, the modules 300 can be provided via a single computing device, such as data processing apparatus 102, or can be distributed via a plurality of computing devices, such as computing devices 102, 104, 106 and/or 108. Moreover, one module can be provided via a single computing device (102, 104, 106 or 108), or can be distributed across a plurality of computing devices.

Included in FIG. 3 is database module 302 that can store various information, including that relate to one or more of: identifiers transmitted by respective transmitters 112; respective software applications configured to provide graphical user interfaces, manage information and provide features shown and described herein and operable with user computing devices 106; user profiles that are associated with each of a plurality of users of user computing devices 106; user purchasing history, such as via web browser history and representational state transfer (“REST”), that can be associated with at least one web page accessed by at least one of the user devices 106; and inventory associated with at least one product and/or service respectively associated with each of a plurality of merchants.

Continuing with reference to FIG. 3, communications module 304 can include hardware and/or software components and be configured to interface with at least one of the respective merchant computing devices 104 and/or user computing devices 106 in response to the user computing device 106 transmitting instructions (e.g., in response to prompts) associated with purchasing a product/service.

Also illustrated in FIG. 3 is SDK module 306 that is configured to provide tools (e.g., class files, packages or other program resources) that enable software developers to implement features such as shown and described herein. Using the SDK module 306, developers can customize software to operate on merchant computing devices 104 and/or user computing devices 106 and configure the devices to receive and/or send information from one or more data processing apparatuses 102 detect, as well as to develop customized software applications (e.g., mobile apps) to operate on one or more devices 104 and 106. The SDK module 306 can be configured to supply appropriate content to a computing device 104, as well as to transmit tracking information associated with a computing device 104/106.

Continuing with reference to FIG. 3, merchant processing module 308 is configured to interface with one or more merchant-based hardware and software systems, including merchant computing devices 104 and databases on storage devices 108, as well as computing devices 106 and data processing apparatus 102. Merchant processing module 308 can include one or more software applications that configure computing devices 104. In one or more implementations, an API Key for merchants can be installed in the software application(s), which can be stored securely, for example, via an operating system (e.g., iOS) level storage.

Continuing with reference to FIG. 3, GPS module 310 can be usable, for example, to identify locations and trajectories of respective user computing devices 106 and for data processing apparatus 102 and/or merchant computing devices 104 to send/receive information associated with users purchasing habits, merchant inventory, sales, special offers or the like that can be accessible in databases 108 and/or user computing devices 104, 106. Further, recommendation module 312 can be included that is configured to determine, generate and/or provide one or more recommendations associated with a particular user computing device 106 and/or product/service associated with merchant database(s) such as stored on storage/database devices 108. The recommendation(s) can be delivered to a respective merchant computing device 104 that is in close proximity (or other suitable relevance) to user computing device 106. Moreover, information, prompts and graphical screen controls can be provided, for example, on computing devices 104 and/or 106 via interface module 314.

In one or more implementations, the present application can include an application programming interface (“API”) module 316 that enables one or more software applications, for example, operating on user computing device 106 and/or a merchant computing device 104 and/or data processing apparatus 102. By providing an API in this way, developers can define and/or update information associated detecting and/or responding to consumer devices, as well as particular actions software applications operating on computing devices 102, 104, 106 and/or 108 take in response to, for example, a location and/or trajectory of a consumer traveling in a vehicle.

In one or more implementations, consumers who are present within transmission range of a transmitter 112 trigger a “GET” interface, which can be provided to receive customer-user-beacon information, identify a particular party (e.g., a merchant), and determine an appropriate beacon content object to return. If none is found a default content object can be returned. The returned object can include two components: user facing information (e.g., HTML content, images, and/or text) and tags. Tags can be transmitted, for example, to data processing apparatus 102, if it appears the user of a computing device 106 has become engaged in the vicinity of respective transmitter 112. Engagement can be time-based (e.g., a minimum period of time that was exceeded in the area), or that the signal strength detected by a computing device 106 became strong (e.g., because a user moved close to the beacon). In one or more implementations, a client software application operating on a user computing device 106 can include settings for identifying a sufficient degree of engagement. Once engaged, tags associated with the transmitter 112 can be transmitted, for example, to data processing apparatus 102.

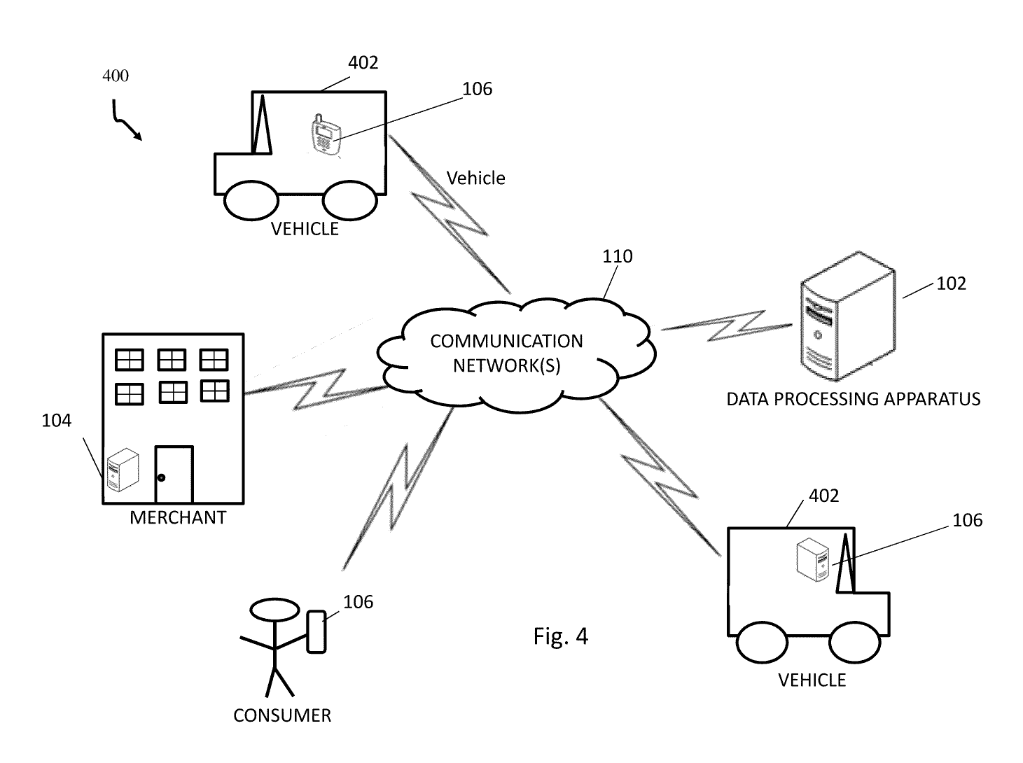

FIG. 4 is a simple block diagram 400 illustrating devices and parties associated with an example implementation of the present patent application. In the example shown in FIG. 4, vehicle 402 include computing devices, such as mobile computing devices 106, and data communication sessions, such as over the network 110, enable transfer of information, messaging, order placement, and scheduling. In one or more of the vehicles 402, a graphical user interface can be provided in a display screen configured with the vehicle's dashboard and that is tied in to the user's mobile computing device 106 (e.g., via BLUETOOTH). Alternatively, the vehicle 402 is internally configured with a computing device 106, thereby obviating a need for an external mobile computing device 106, such as a smartphone, tablet computer or other external mobile device. The user interface can be developed and implemented via SDK module 306 and/or API module 316, and can be provided via interface module 314. Further, information provided via the interface module 314 can be accessed by database module 302 (e.g., vis-à-vis databases stored on one or more storage/database devices 108).

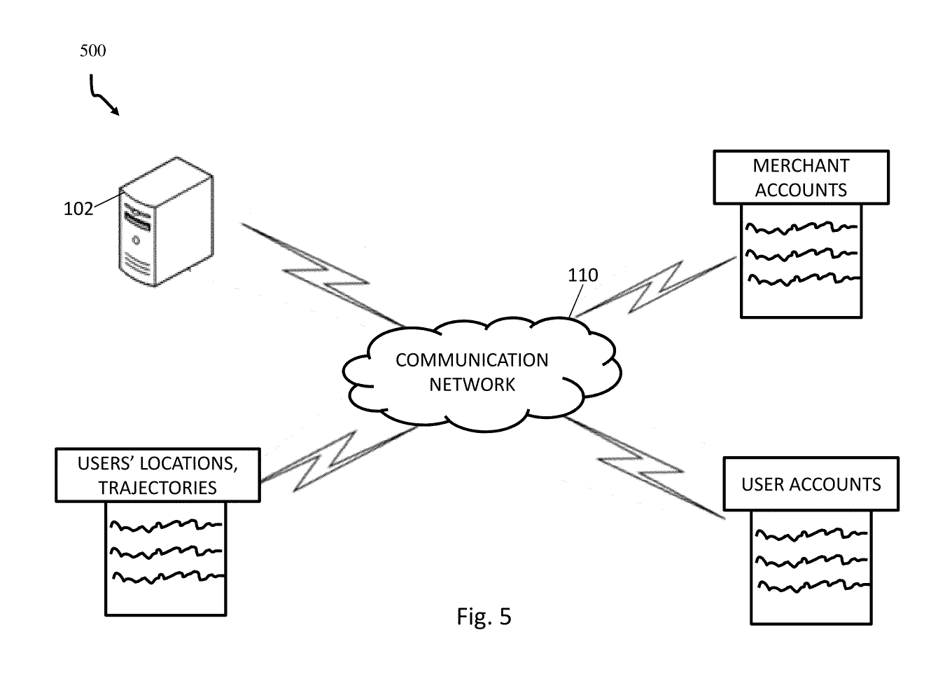

FIG. 5 is a simple block diagram 500 illustrating information stored in one or more storage/database devices 108, and that is accessible to data processing apparatus 102, merchant devices 104 and/or user computing devices 106. Information that may be accessible to data processing apparatus, including for enabling or otherwise providing the features shown herein can include information associated with merchant accounts, e.g., history of purchased products/services, current inventory, contact information, location information, specials, or other information associated with a merchant. In addition to information relating to merchants, information associated with user accounts is accessible, such as information associated with previous purchases, user computing device and software application installation information, and other user account information, such as relating to user contact information. Moreover, mobile device location information can be provided, which can relate, for example, to the location and/or traveling trajectory of a vehicle 402 at a given time. Using device location information, data processing apparatus 102 can determine that a user is near or approaching a merchant from whom the user has previously purchased a product and/or service and may be inclined to purchase from again. Upon such determination, a purchase recommendation or order can be instigated and provided to the user, for example, via a graphical user interface provided in a display screen configured in the user's automobile dashboard.

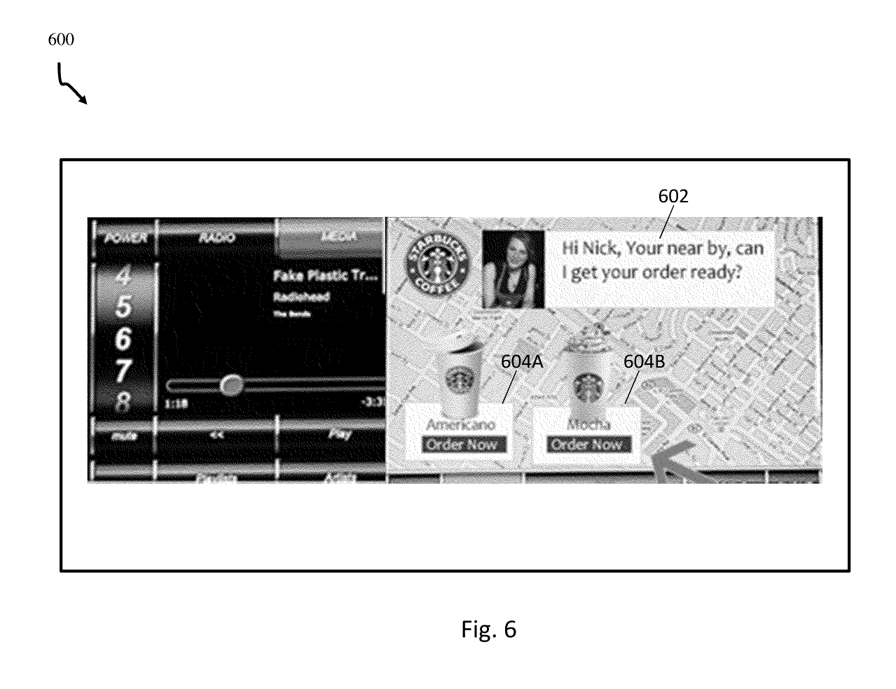

FIG. 6 illustrates an example display screen 600 that is provided in a vehicle 402 dashboard, and that displays a map representing the user's whereabouts, such as provided via a global positioning system (GPS). An app, such as executing via a mobile computing device or via a processor configured with the vehicle 402, operates to track the user's whereabouts. In the example display screen 600, user interface is provided, such as via user interface module 314. Included therein, is a message section 602, such as provided via communications module 304 and/or recommender module 312, that can be retrieved (e.g., via database module 302) or provided substantially in real-time (e.g., via communications module 304/recommender module 312) via short message service (“SMS”) messaging, video messaging, voice or other medium. As shown in the example display screen 600, shown at message section 602 in FIG. 6, an image of a salesperson from a coffee shop is displayed and a message informing the user “Nick” that it is determined that he is nearby, and asking whether to get an order ready. In one or more implementations of the present application, a determination is made, for example, based on previous purchasing habits that Nick prefers a specific style of coffee drink, e.g., an “AMERICANO.” It is also determined, however, that at particular times and/or days, Nick's preference changes for a different kind of drink, e.g., a “MOCHA.” Accordingly, two options (604A, 604B) are provided to the user that correspond to products determined to be preferred by Nick (i.e., AMERICANO and MOCHA). Thus and as illustrated in FIG. 6, the present application provides systems and methods that include information being processed to determine a user's purchasing habits and to anticipate a user's desire to purchase a product and/or service at a particular time. Options can be provided for the user to select one or more products, including via a graphical user interface provided in a vehicle 402 dashboard, as well as to display a message from a merchant and/or to engage in a dialog with a representative of a merchant.

In response to a user making a selection of a product (or service), an order can be transmitted to the merchant's location. In one or implementations, the order is generated by data processing apparatus 102, in response to the selection, and transmitted to a merchant computing device 104, such as via communications module 304. Alternatively (or in addition), the order is generated by a user computing device 106 in or with the vehicle 402, for example via an app executing thereon. The order can be transmitted, such as via communications module 304, from the user computing device 106 to the merchant computing device 104. In addition, the order can be paid for in advance of the user picking up the order, such as in connection with one or more accounts (e.g., pre-paid paid accounts) held by the user. In response to the received order (and possible payment), the merchant can fulfill the order.

In one or more implementations, a merchant's location can be configured with one or more transmitters 112. A merchant computing device 104 can process information received from the respective user device 106 (including in response to the user computing device 106 detecting a signal from the transmitter 112), and a determination can be made that the order associated with the user has been fulfilled. For example, a representative at the merchant's location can be informed, such as via the merchant's computing device 104, that the user is present and inform the merchant to deliver the order to the user. In one or more implementations, a message can be provided on the user's computing device 106 to move to the front of a line to pick up the order, such as in the event that the order is prepaid. In another implementation, the merchant may have a drive-in window or other quick access for pick-up and as the user arrives, the order is ready for pickup.

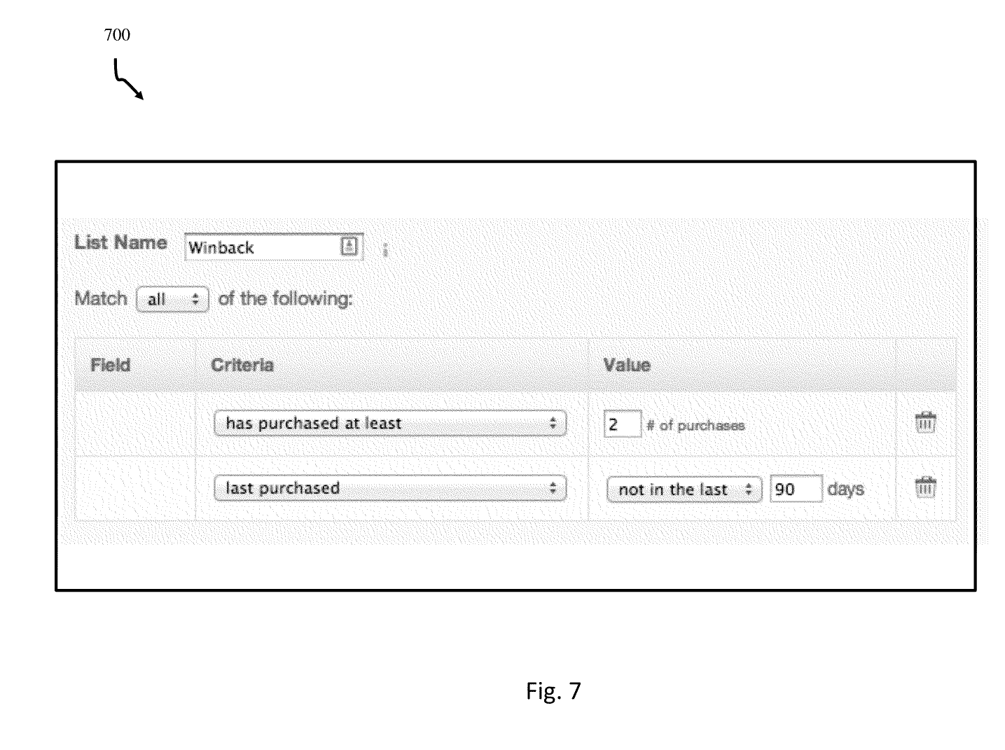

Criteria for submitting information to users, such as to make recommendations and/or place orders as shown and described herein, can be defined by authorized users, such as associated with a merchant. FIG. 7 is an example data entry display screen 700 which is usable to receive information from users to set one or more conditions associated with communications for product/service purchasing. In the example shown in display screen 700, members of a list name, “Winback” are to be selected for those who match criteria that include that a member of the list has not made at least two purchases of a respective product/service within the last ninety (90) days. Members of the Winback list that satisfy such criteria can be contacted, such as shown and described herein, with a suggestion and/or pre-purchase of a product/service. In addition (or in the alterative), a communication session can be established (e.g., via communications module 304) between a user and a merchant to effect a purchase of a product and/or service. The communications module 304 can be configured to establish various forms of sessions, such as SMS, VOX, Video or other suitable protocol, for example, as supported by one or more communication devices and/or platforms.

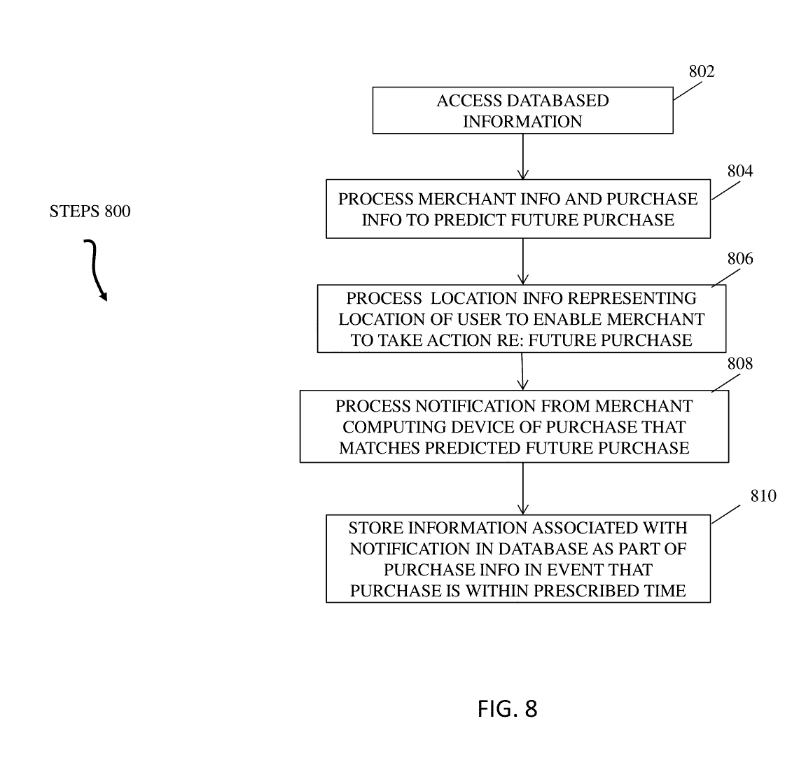

Turning now to FIG. 8, a flow diagram is described showing a routine 800 that illustrates a broad aspect of a method for providing a targeted recommendation for a product or service in accordance with at least one implementation disclosed herein. It should be appreciated that several of the logical operations described herein are implemented (1) as a sequence of computer implemented acts or program modules running on computing device 102/104 and/or (2) as interconnected machine logic circuits or circuit modules within computing device 102/104/106. The implementation is a matter of choice and can be (though not necessarily) dependent on the requirements of the device (e.g., size, mobility, energy, consumption, performance, etc.). Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Continuing with the flowchart shown in FIG. 8, steps 800 are associated with an example implementation of the present application that includes determining that a consumer will purchase a product or service based, at least in part, on a location and/or trajectory of a vehicle the consumer is in and a purchasing habit of the consumer. In some implementations, the process 800 can be performed by a processor executing instructions in a computer-readable storage medium, and occurs in response to a user device 106 operating a respective software application that interfaces with or operates within a computing device configured in an automobile dashboard.

At step 802, at least one database is accessed that includes electronic merchant information and electronic purchasing information. The electronic merchant information can include, for each of a plurality of respective merchants, at least one of a name and a location of the product and/or service, and the electronic purchasing information can include, for each of a plurality of respective consumers, past purchasing behavior relating to the products and/or services sold by at least one of the respective merchants. Thereafter, using at least one processor, at least some of the electronic merchant information and the electronic purchasing information is processed to predict a future purchase of the product or service by the consumer from one of the respective merchants (step 804). At step 806, further processing is triggered, using at least one processor, location information that represents a location of the consumer to enable the one of the respective merchants to take action in view of the predicted future purchase. Thereafter, the process continues and a notification is received over a data communication network, using at least one processor, from a computing device associated with one of the respective merchants that represents a purchase by the consumer (step 808). The purchase by the consumer matches the predicted future purchase. At step 810, information associated with the notification is selectively stored, using at least one processor, in the at least one database as part of the electronic purchasing information in the event that the matching purchase is within a prescribed time of the triggered processing in step 808.

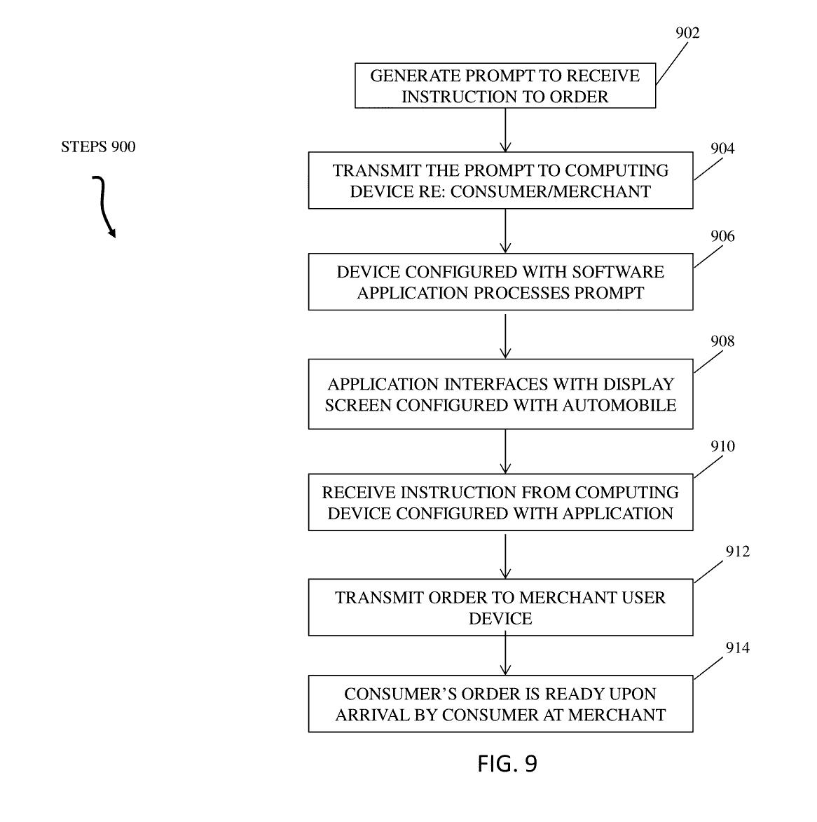

FIG. 9 is a flowchart illustrating steps 900 associated with an example implementation of the present application. In the example steps 900 shown in FIG. 9, a prompt is generated using at least one processor that is usable to receive an instruction from a consumer to order products and/or services from one respective merchant (step 902). The prompt is transmitted, using at least one processor, to at least one of a computing device operated by the consumer and a computing device operated by one of the respective merchants (step 904). A computing device operated by the consumer is a mobile computing device configured with a software application, and the prompt is processed by the mobile computing device configured with the software application (step 906). The software application interfaces, at least in part, with a display screen configured in an automobile, and any instruction provided by the consumer to order the products and/or services is acknowledged in a graphical user interface provided in the display screen (step 908). The instruction from the computing device operated by the consumer is received, using at least one processor (step 910). An order for the products and/or services is transmitted, using at least one processor, to one of the respective merchants as a function of the received instruction (912). By the time the consumer arrives at the merchant's location, the order is ready for pickup.

In accordance with the teachings herein, it will be appreciated that many and various implementations of the present application can be applied to this technology. For example, personalized content can be provided as a function of a unique identifier included with the consumer's computing device and/or software application configuring the device. Alternatively, generic messaging is supported, such that every user of a computing device 106 is provided a similar generic message with an additional option to select and place an order for a product/service, such as an image of a coffee and donut appearing in a dashboard of a user's automobile.

Thus, as shown and described herein, automobile dashboards configured with display devices (e.g., display screens) can be leveraged to provide concise and direct amounts of information in area(s) where a driver would be otherwise limited in the amount of information or decision level the drive can make due to the level of concentration needed to drive. Moreover, the present application provides for efficient and time-sensitive decision-making for drivers, for example, without requiring a driver to stop the car and use the phone, or pull over to use navigation systems when voice control is not viable.

The present application improves upon known systems in which, for example, tasks associated with searching for a particular merchant often result using voice navigation. By providing interactive and automatic prompts for ordering products and/or services in accordance with at least past purchasing habits and vehicle location/trajectory, the present application eliminates the cumbersome and distracting process consumers and drivers would otherwise be faced with. Moreover, the present application can locate restaurants, stores or other venues, such as via database module 302 and merchant processing module 308, to provide consumers with options in areas (e.g., cities) where the consumer is visiting or otherwise would not be familiar. Furthermore, by providing personalized recommendations, the present application provides information that the consumer is likely to be interested in, which enables quick decisions and reduces distractions. For example, rather than providing a list of locations that are near a user, the present application can provide a list of restaurants/coffee shops/stores that is known that the driver/consumer is likely to be interested in. In addition, suggestions can be made of items available at those locations that the consumer is likely to order, based on previous purchases.

Additionally, the present application can integrate an ordering system to the process, which eliminates the wait that often happens during travelling and stopping for food/beverages. Using location-aware devices, merchants can be made aware of a consumer's location, as well as an estimate of how long it will take for the consumer to arrive at the location. This streamlines ordering and improves efficiency. Also drivers can be made aware of potential delays (e.g., wait times), which can lead to better and more efficient decision making in the selection of an order and/or merchant. Furthermore, the present application can tie into a merchant's point of sale system, and information regarding predicted purchases that were made can be received from merchants, which contributes to the overall efficiency and accuracy of the present application.

The subject matter described above is provided by way of illustration only and should not be construed as limiting. Various modifications and changes can be made to the subject matter described herein without following the example embodiments and applications illustrated and described, and without departing from the true spirit and scope of the present invention, as set forth in each and any of the following claims.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for determining that a consumer will purchase a product or service based, at least in part, on a location and/or trajectory of a vehicle the consumer is in and a purchasing habit of the consumer, the method comprising:
accessing, using at least one processor, at least one database that includes electronic merchant information and electronic purchasing information,
wherein the electronic merchant information includes, for each of a plurality of respective merchants, at least one of a name and a location of the product and/or service, and
wherein the electronic purchasing information includes, for each of a plurality of respective consumers, past purchasing behavior relating to the products and/or services sold by at least one of the respective merchants;
processing, using at least one processor, at least some of the electronic merchant information and the electronic purchasing information to predict a future purchase of the product or service by the consumer from one of the respective merchants;
triggering further processing, using at least one processor, of location information that represents a location of the consumer to enable the one of the respective merchants to take action in view of the predicted future purchase;
receiving over a data communication network, using at least one processor, a notification from a computing device associated with one of the respective merchants that represents a purchase by the consumer, wherein the purchase by the consumer matches the predicted future purchase; and
selectively storing, using at least one processor, information associated with the notification in the at least one database as part of the electronic purchasing information in the event that the matching purchase is within a prescribed time of the triggered further processing.

2. The method of claim 1, further comprising:
generating, using at least one processor, a prompt that is usable to receive an instruction from the consumer to order the products and/or services from one of the respective merchants; and
transmitting, using at least one processor, the prompt to at least one of a computing device operated by the consumer and a computing device operated by one of the respective merchants.

3. The method of claim 2, wherein the computing device operated by the consumer is a mobile computing device configured with a software application, and wherein the prompt is processed by the mobile computing device configured with the software application.

4. The method of claim 3, wherein the software application interfaces, at least in part, with a display screen configured in an automobile, and wherein any instruction provided by the consumer to order the products and/or services is acknowledged in a graphical user interface provided in the display screen.

5. The method of claim 1, wherein payment for the purchase is made in advance of the purchase.

6. The method of claim 1, wherein the consumer's location is derived from a global positioning system.

7. The method of claim 2, further comprising:
receiving, using at least one processor, the instruction from the computing device operated by the consumer; and
transmitting, using at least one processor, an order for the products and/or services to one of the respective merchants as a function of the received instruction.

8. The method of claim 2, further comprising receiving, using at least one processor, a notification that the consumer did not respond to the prompt.

9. The method of claim 1, wherein the electronic purchasing information further comprises at least one of: a web site previously visited by the consumer; products and/or services previously viewed by the consumer; and an advertisement that was provided to the consumer,
wherein the processing of at least some of the electronic merchant information and the electronic purchasing information to predict the future purchase further comprises accounting for at least one of: the web site previously visited by the consumer; the product and/or service previously viewed by the consumer; and the advertisement that was provided to the consumer.

10. A method for predicting interest of a consumer to purchase a product or service based, at least in part, on a location or trajectory of a vehicle and a purchasing history of the consumer, the method comprising:
conveying location information representing the location or trajectory to a computing device outside of the vehicle;
prompting the consumer, as a function of the location information and purchasing history of the consumer and by using a computer-based system within the vehicle, with at least one option to order the product or service;
processing, using at least one processor, a response to the prompt that represents an affirmative instruction from the consumer to order the product or service;
transmitting, using at least one processor, the instruction to a merchant;
receiving over a data communication network, using at least one processor, a notification from a computing device associated with one of the respective merchants representing that the consumer purchased the product or service; and
selectively storing, using at least one processor, information associated with the notification in at least one database.

11. A system, the system comprising:
at least one processor configured to execute code that results in a special purpose device for determining that a consumer will purchase a product or service based, at least in part, on a location and/or trajectory of a vehicle the consumer is in and a purchasing habit of the consumer, wherein the processor is configured to:
access at least one database that includes electronic merchant information and electronic purchasing information,
wherein the electronic merchant information includes, for each of a plurality of respective merchants, at least one of a name and a location of the product and/or service, and
wherein the electronic purchasing information includes, for each of a plurality of respective consumers, past purchasing behavior relating to the products and/or services sold by at least one of the respective merchants;
process at least some of the electronic merchant information and the electronic purchasing information to predict a future purchase of the product or service by the consumer from one of the respective merchants;
trigger further processing of location information that represents a location of the consumer to enable the one of the respective merchants to take action in view of the predicted future purchase;
receive over a data communication network a notification from a computing device associated with one of the respective merchants that represents a purchase by the consumer, wherein the purchase by the consumer matches the predicted future purchase; and
selectively store information associated with the notification in the at least one database as part of the electronic purchasing information in the event that the matching purchase is within a prescribed time of the triggered further processing.

12. The system of claim 11, wherein the processor is further configured to:
generating, using at least one processor, a prompt that is usable to receive an instruction from the consumer to order the products and/or services from one of the respective merchants; and
transmitting, using at least one processor, the prompt to at least one of a computing device operated by the consumer and a computing device operated by one of the respective merchants.

13. The system of claim 12, wherein the computing device operated by the consumer is a mobile computing device configured with a software application, and wherein the prompt is processed by the mobile computing device configured with the software application.

14. The system of claim 13, wherein the software application interfaces, at least in part, with a display screen configured in an automobile, and wherein any instruction provided by the consumer to order the products and/or services is acknowledged in a graphical user interface provided in the display screen.

15. The system of claim 11, wherein payment for the purchase is made in advance of the purchase.

16. The system of claim 11, wherein the consumer's location is derived from a global positioning system.

17. The system of claim 12, wherein the processor is further configured to:
receive the instruction from the computing device operated by the consumer; and
transmit an order for the products and/or services to one of the respective merchants as a function of the received instruction.

18. The system of claim 12, wherein the processor is further configured to
receive a notification that the consumer did not respond to the prompt.

19. The system of claim 11, wherein the electronic purchasing information further comprises at least one of: a web site previously visited by the consumer; products and/or services previously viewed by the consumer; and an advertisement that was provided to the consumer, wherein the processing of at least some of the electronic merchant information and the electronic purchasing information to predict the future purchase further comprises accounting for at least one of: the web site previously visited by the consumer; the product and/or service previously viewed by the consumer; and the advertisement that was provided to the consumer.
